(19) United States
(12) Patent Application Publication
(10) Pub. No.: US 2010/0140962 A1
(43) Pub. Date: Jun. 10, 2010

(54) MORTISE LOCK

(76) Inventor: Gab-Sik Kim, Seoul (KR)

Correspondence Address: BIRCH STEWART KOLASCH & BIRCH, PO BOX 747, FALLS CHURCH, VA, 22040-0747, US

(21) Appl. No.: 11/909,448

(22) PCT Filed: Mar. 23, 2006
(86) PCT No.: PCT/KR2006/001055

§ 371 Date: Sep. 21, 2007

(30) Foreign Application Priority Data
Mar. 24, 2005 (KR) 10-2005-0024459

(51) Int. Cl. E05C 1/12

(52) U.S. Cl. 292/165

(57) ABSTRACT

Disclosed is a mortise lock having a latch bolt serving as a dead bolt. The mortise lock comprises a case including a front wall having an opening and a lateral wall having a latch tongue hook hole; a latch bolt including a body and heads, the heads having a first part extended from the body and exposed to the outside of the case through the opening formed in the front wall and a second part obliquely extended from an end of the first part; and a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion, wherein the rotational shaft of the latch tongue is rotatably moved into the case by a force, which is given to allow the striking plate of the door frame to push the protrusion of the latch tongue, so as to insert the first part of the heads of the latch bolt into the case, and the striking plate of the door frame pushes an inclined surface of the second part of the heads of the latch bolt so as to insert the second part of the heads into the case.

### TECHNICAL FIELD

The present invention relates to a mortise lock, and more particularly, to a mortise lock having a latch bolt serving as a dead bolt.

### BACKGROUND ART

A locking apparatus called a mortise lock is generally used for a door connected to a door frame by a hinge.

The mortise lock is provided at an opposite corner of the hinge of the door, so that a latch bolt externally exposed is pushed by a striking plate provided in a door frame of a wooden material or an iron plate and inserted into a mortise lock case when the door is closed by rotation and a dead bolt provided in the mortise lock is inserted into a service hole of the door frame after the door is closed, thereby ensuring locking of the door.

When the door is closed, to insert the latch bolt of the mortise lock into the mortise lock case as the latch bolt is pushed by the striking plate of the door frame, a length of the latch bolt extended toward the outside the mortise lock case is already determined. In most cases, the latch bolt has a length of ¾ inch (about 19 mm).

When the distance between the door and the door frame becomes wide, the length of the latch bolt inserted into the service hole of the door frame becomes short. Accordingly, it is necessary to uniformly maintain the distance between the door and the door frame. However, the distance between the door and the door frame may become too wide due to error in construction of the door and the door frame. Even though the distance between the door and the door frame is uniformly maintained, the door and the door frame may be contracted and expanded due to temperature change and humidity exchange of the indoor environment when they are constructed. For this reason, it is difficult to uniformly maintain the distance between the door and the door frame.

To supplement the short length of the latch bolt inserted into the service hole of the door frame, the mortise lock is conventionally provided with a dead bolt that can be extended longer than the latch bolt.

The dead bolt is inserted into the service hole of the door frame to ensure locking of the door after the door is closed. The dead bolt is manually operated after the door is closed as the latch bolt of the mortise lock is inserted into the service hole of the door frame.

In the mortise lock having a dead bolt, a manual locking operation of the dead bolt is required after the door is closed. Such a manual locking operation of the dead bolt makes a user inconvenient and also causes a complicated structure of the mortise lock.

### DISCLOSURE OF INVENTION

### Technical Problem

Accordingly, an object of the present invention is to provide a mortise lock having a latch bolt serving as a dead bolt.

### Technical Solution

To achieve the object of the present invention, a mortise lock comprises a case including a front wall having an opening and a lateral wall having a latch tongue hook hole; a latch bolt including a body and heads, the heads having a first part extended from the body and exposed to the outside of the case through the opening formed in the front wall and a second part obliquely extended from an end of the first part; and a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion, wherein the rotational shaft of the latch tongue is rotatably moved into the case by a force, which is given to allow the striking plate of the door frame to push the protrusion of the latch tongue, so as to insert the first part of the heads of the latch bolt into the case, and the striking plate of the door frame pushes an inclined surface of the second part of the heads of the latch bolt so as to insert the second part of the heads into the case.

In another aspect of the present invention, a mortise lock comprises a case including a front wall having an opening and a lateral wall having a latch tongue hook hole; a latch bolt including a body and heads, the heads having a first part extended from the body and exposed to the outside of the case through the opening formed in the front wall and a second part obliquely extended from an end of the first part to have a gradually decreased sectional area; and a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion, wherein the rotational shaft of the latch tongue is rotatably moved into the case by a force, which is given to allow the striking plate of the door frame to push the protrusion of the latch tongue, so as to insert the first part of the heads of the latch bolt into the case, and the striking plate of the door frame pushes an inclined surface of the second part of the heads of the latch bolt so as to insert the second part of the heads into the case.

In other aspect of the present invention, a mortise lock comprises a case including a front wall having an opening and a lateral wall having a latch tongue hook hole; a latch bolt including a body and heads, the heads having a first part of a constant sectional area extended from the body and exposed to the outside of the case through the opening formed in the front wall, and a second part obliquely extended from an end of the first part to have a gradually decreased sectional area; and a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion, wherein the rotational shaft of the latch tongue is rotatably moved into the case by a force, which is given to allow the striking plate of the door frame to push the protrusion of the latch tongue, in a state that the hook of the latch tongue is hanging on the latch tongue hook hole until the protrusion of the latch tongue becomes identical with a height of the first part of the latch bolt, and the striking plate of the door frame pushes the second part of the heads of the latch bolt so as to insert the second part of the heads into the case after the protrusion of the latch tongue becomes identical with the eight of the first part of the latch bolt.

### ADVANTAGEOUS EFFECTS

A mortise lock according to the present invention provides a latch bolt serving as a dead bolt.

### BRIEF DESCRIPTION OF THE DRAWINGS

FIG. 1 is a perspective view illustrating a mortise lock according to the present invention, viewed from a right side;

FIG. 2 is a perspective view illustrating a mortise lock according to the present invention, viewed from a left side;

FIG. 3 is an exploded perspective view illustrating the inside of a mortise lock after opening its cover;

FIG. 4 is an exploded perspective view illustrating parts of a mortise lock;

FIG. 5 is a perspective view illustrating a latch bolt; and

FIG. 6 is an exploded perspective view illustrating parts of a latch bolt.

### BEST MODE FOR CARRYING OUT THE INVENTION

Reference will now be made in detail to the preferred embodiments of the present invention, examples of which are illustrated in the accompanying drawings.

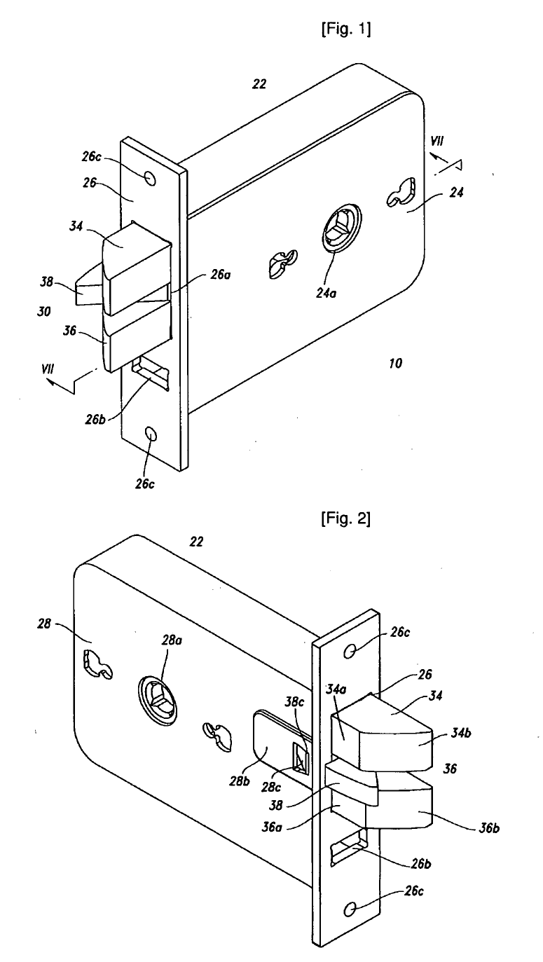

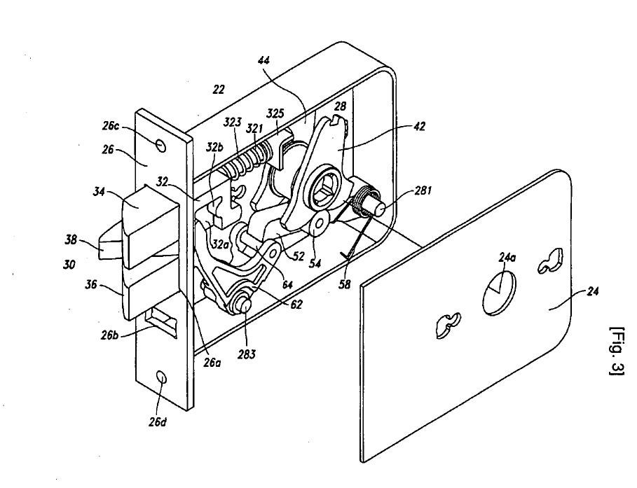

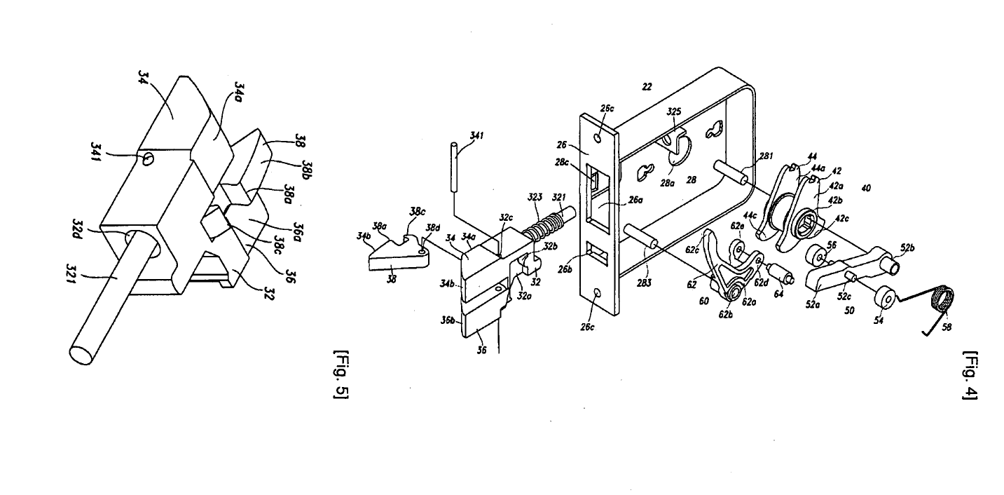

FIG. 1 is a perspective view illustrating a mortise lock according to the present invention, viewed from a right side, and FIG. 2 is a perspective view illustrating a mortise lock according to the present invention, viewed from a left side.

Referring to FIGS. 1 and 2, the mortise lock according to the present invention is given as a reference numeral 10. The mortise lock 10 includes a case 22 of a rectangular parallelepiped, wherein lock elements are received in an inner space of the case 22. The inner space of the case 22 is closed by a cover 24 after the lock elements are received therein. An opposite side 28 of the cover 24 constitutes one side of the case 22.

The cover 24 is provided with a spindle through hole 24a of a circular shape. A spindle connected with a door handle and rotated by the door handle is fitted into a hub 42 (see FIGS. 3 and 4) through the spindle through hole 24a formed in the cover 24, wherein the hub 42 is positioned inside the case 22.

The opposite side 28 of the cover 24 is also provided with a spindle through hole 28a of a circular shape. A spindle connected with another door handle and rotated by the door handle is fitted into another hub 44 (see FIGS. 3 and 4) through the spindle through hole 28a formed in the opposite side 28 of the cover 24, wherein the hub 44 is positioned inside the case 22.

A front plate 26 is fixed to the case 22 on a front surface of the case 22. Screw holes 26c and 26d are formed near upper and lower corners of the front plate 26 so that the mortise lock 10 can be installed in a door. A rectangular latch bolt outlet 26a is formed at the center of the case 22. In this case, the latch bolt outlet 26a is opened.

Heads 34 and 36 of the latch bolt 30 are inserted from the outside of the case into the inside of the case through the latch bolt outlet 26a formed in the front plate 26 or are taken out of the inside of the case toward the outside of the case.

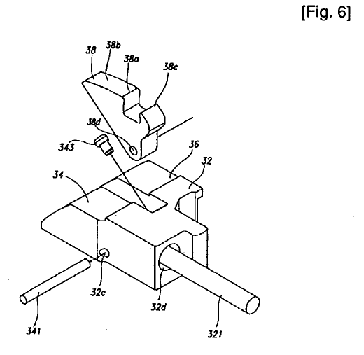

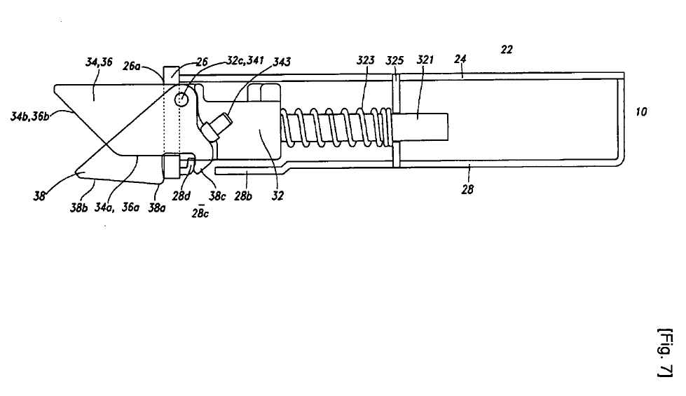

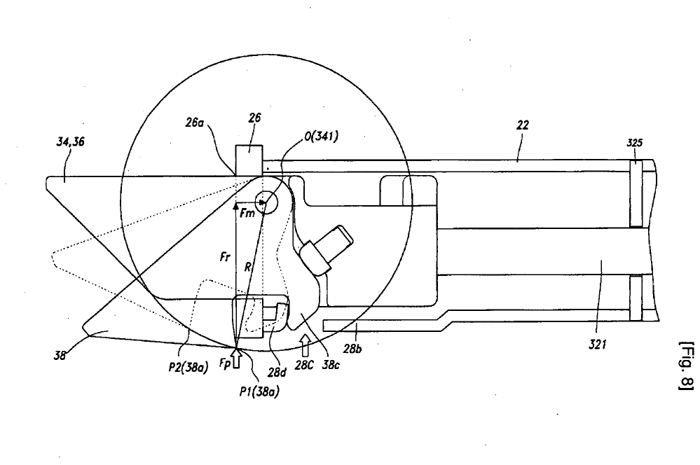

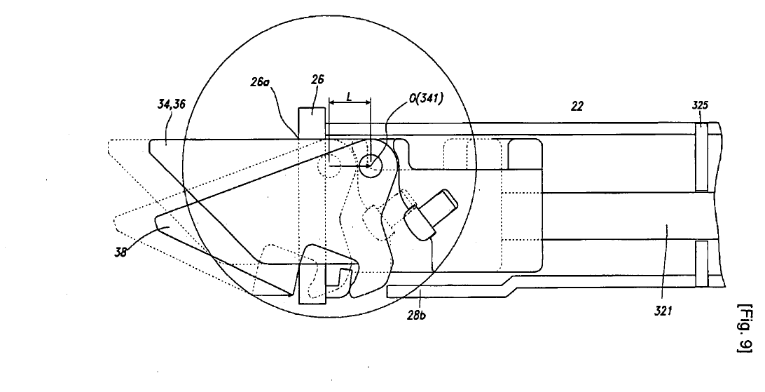

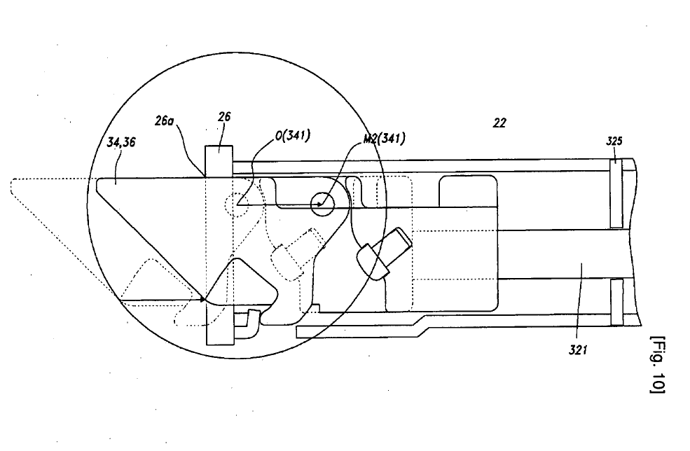

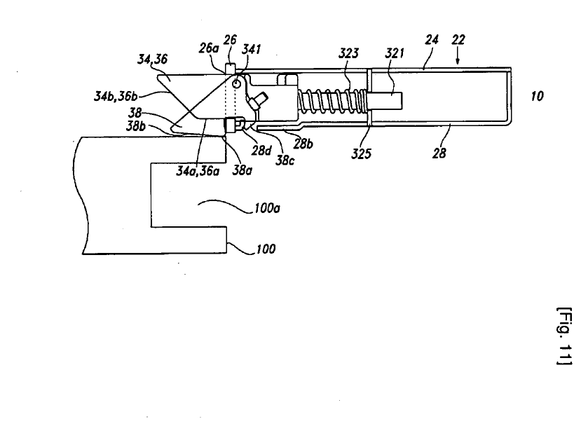

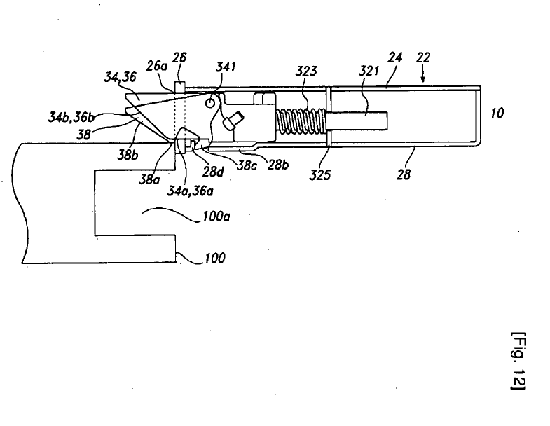

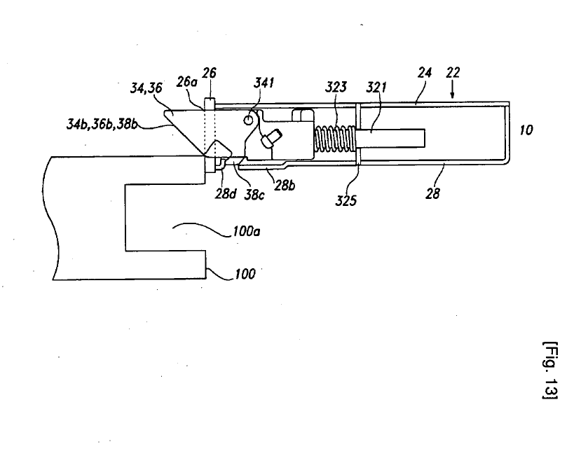

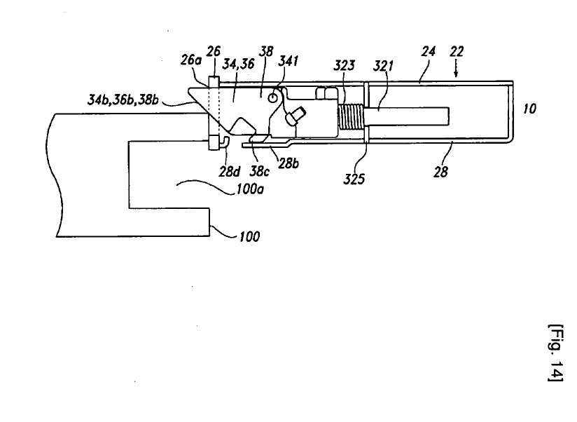

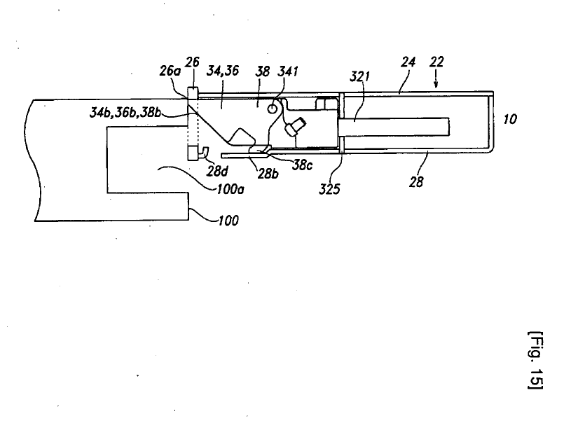

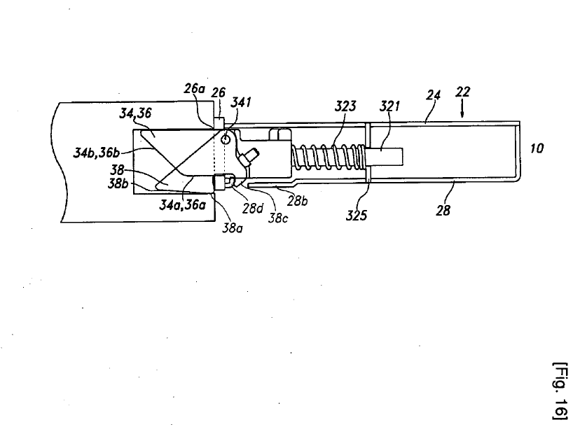

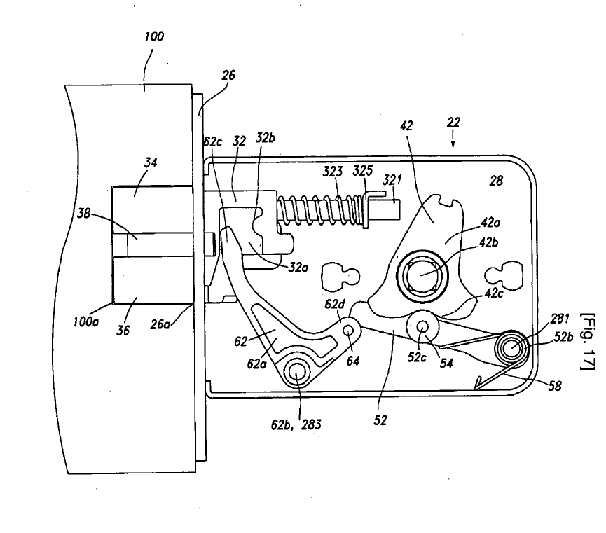

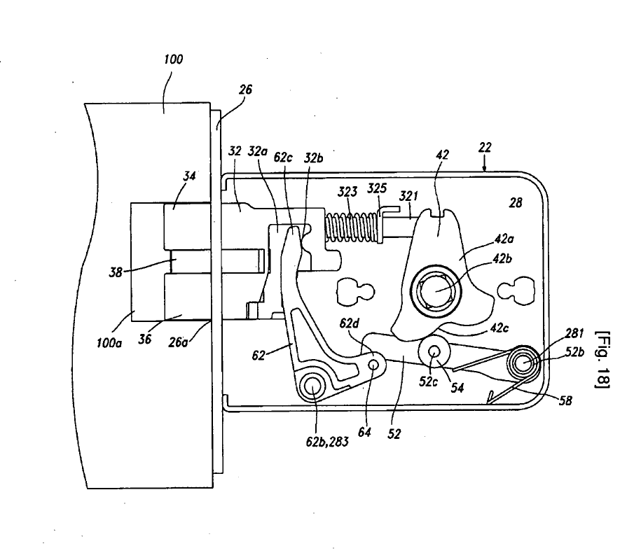

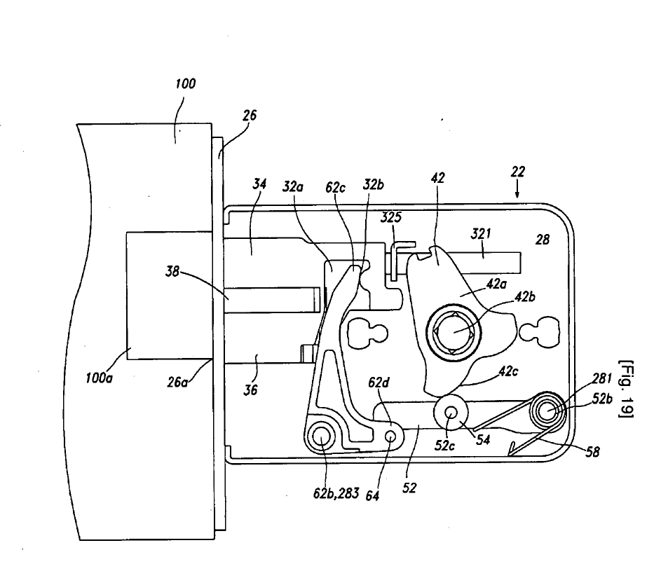

The latch bolt 30, as shown in FIGS. 5 and 6, includes a body 32, the heads 34 and 36, and a latch tongue 38. The heads 34 and 36 are extended from the body 32 and divided into two upper and lower parts. The latch tongue 38 is positioned between the heads 34 and 36 and rotates. The heads 34 and 36 of the latch bolt are again divided into planes 34a and 36a extended at a certain distance in parallel with the opposite side and inclined surfaces 34b and 36b extended from the planes 34a and 36a. The planes 34a and 36a of the heads 34 and 36 make the length of the latch bolt taken out of the latch bolt outlet 26a of the front plate 26 longer.

The latch tongue 38 is protruded more than the planes 34a and 36a of the heads 34 and 36 of the latch bolt so that the planes 34a and 36a of the heads 34 and 36 extended from the body 32 of the latch bolt do not collide with the striking plate of the door frame. When the door is closed, the latch tongue 38 is inserted between the heads of the latch bolt while rotating and at the same time pulls the extended planes 34a and 36a of the heads to insert them into the case. This operation will be described in detail with reference to FIG. 8. Also, the structure of the latch bolt will be described in detail with reference to FIGS. 5 and 6.

The inner structure of the mortise lock according to the present invention will be described with reference to FIGS. 3 and 4.

The hub 40 to which the spindle rotated by the door handle is inserted includes a first hub member 42 connected with a spindle connected with an outer door handle and rotated by the outer door handle and a second hub member 44 connected with a spindle connected with an inner door handle and rotated by the inner door handle. Cam surfaces 42c and 44c are respectively formed below the hub members 42 and 44.

A push lever 50 is located below the hub 40. One end of the push lever 50 moves down when the hub is rotated. The push lever 50 includes a bar shaped push lever member 52. One of the push lever member 52 rotates in a state that it is fitted into a first boss 281 of the case. A pin 52c is fitted into the center portion of the push lever member 52, and rotating rings 54 and 56 are fitted into the pin 52c. The rotating rings 54 and 56 are in contact with the cam surfaces 42c and 44c formed below the hub members 42 and 44 so that their ends move down when the hub is rotated. A spring 58 is positioned below the push lever member 50 to return the push lever member moved down to its original position.

A latch mechanism 30 is positioned inside the case 22 integrally formed, and heads 34 and 36 of the latch mechanism 30 are exposed through an opening 26a of the front plate 26. The through hole 28a is formed at a side of the case 22 to pass a rotary shaft of the handle therethrough, and the first and second bosses 281 and 283 are protruded inside the case. Holes 62d and 62e are made at one side of the lever 60. A rotating member 64 is fitted into the holes 62d and 62e. The lever 60 rotates around the second boss 283 serving as a pivot shaft in a state that it is fitted into the second boss 283.

The rotating member 64 fitted into the holes 62d and 62e of the lever 60 is in contact with one end of the push lever member to rotate the lever 60 when one end of the push lever member moves down. A protrusion 62c of the lever 60 is fitted into a groove 32b formed in the body of the latch bolt and serves to pull the heads 34 and 36 of the latch bolt 30 into the case while the lever 60 is rotating.

Next, the structure of the latch mechanism will be described.

The latch bolt 30, as shown in FIGS. 5 and 6, includes a body 32, heads 34 and 36, a latch bolt tail 321, and a latch tongue 38. The heads 34 and 36 are extended from the body 32 and divided into two upper and lower parts. The latch bolt tail 321 is fixed to the body 32. The latch tongue 38 is positioned at the rear of the heads 34 and 36 and rotates. The heads 34 and 36 of the latch bolt are again divided into planes 34a and 36a extended at a certain distance in parallel with the opposite side and inclined surfaces 34b and 36b extended from the planes 34a and 36a.

The planes 34a and 36a of the heads 34 and 36 make the length of the latch bolt taken out of the latch bolt outlet 26a of the front plate 26 longer. The latch tongue 38 is protruded more than the planes 34a and 36a of the heads 34 and 36 so that planes 34a and 36a of the heads 34 and 36 extended from the body 32 of the latch bolt do not collide with the striking plate of the door frame.

When the door is closed, the latch tongue 38 is first in contact with the striking plate of the door frame to allow the planes 34a and 36a of the heads of the latch bolt into the case while being pushed by the striking plate of the door frame and rotating. As a result, the planes 34a and 36a of the heads do not coincide with the striking plate of the door frame. To this end, the latch tongue 38 is higher than the planes 34a and 36a of the heads 34 and 36 of the latch bolt.

A protrusion 28b protruded toward the rear from the latch bolt outlet 26a is formed at the left side 28. The protrusion 28b serves as a moving path of a latch tongue hook when the inclined surfaces 34b and 36b of the heads are inserted into the case through the latch bolt outlet 26a. A rectangularly opened hook hole 28c is formed at the front of the protrusion 28b to allow the rear side of the latch tongue 38 to be hung on the hook hole.

One end of the latch tongue 38 is protruded higher than the heads 34 and 36 of the latch bolt so that it is to be pushed by the striking plate of the door frame earlier than the heads 34 and 36 of the latch bolt are when the door is closed. The latch tongue 38 allows the planes of the heads 34 and 36 to be inserted into the mortise lock case while being pushed by the striking plate of the door frame.

FIG. 7 is a plane view taken along line VII-VII shown in FIG. 1.

The front plate 26 is fixed to the case 22 on the front surface of the case 22. The rectangularly opened latch bolt outlet 26a is formed at the center of the front plate 26.

The heads 34 and 36 of the latch bolt 30 are inserted from the outside of the case into the inside of the case through the latch bolt outlet 26a formed in the front plate 26 or are taken out of the inside of the case toward the outside of the case.

The operation principle of the mortise lock according to the present invention will be described with reference to FIGS. 8 to 10.

First, as shown in FIG. 8, since the latch tongue 38 is connected with the latch bolt by the rotating pin 341, it rotates around the rotating pin 341. At this time, since the distance R between the rotating pin 341 and the protrusion 38a of the latch tongue 38 is uniformly maintained, the protrusion 38a of the latch tongue 38 is positioned on an arc of a radius R around (O) the rotating pin 341 when the striking plate of the door frame pushes the protrusion 38a of the latch tongue 38 along an arrow.

However, since the rear side of the latch tongue 38 is hanging on the groove formed in the side 28d, the latch tongue 38 cannot be rotated until it moves to the right side. The force of the striking plate pushing the protrusion 38a of the latch tongue 38 along the arrow is divided into a vertical force for rotating the latch tongue and a horizontal force moving the latch tongue to the right side. Accordingly, when the striking plate pushes the protrusion 38a of the latch tongue 38 along the arrow, the latch tongue 38 rotates while moving to the right side.

Supposing that the latch tongue does not move, the distance L required to move the latch tongue 39 to the right side is determined as the distance between a vertical line drawn at a portion where the protrusion 38a of the latch tongue 38 upwardly moved by rotation meets the arc of the radius R around (O) the rotating pin 341 and a vertical line originally drawn at the protrusion 38a of the latch tongue 38.

Accordingly, when the striking plate pushes the protrusion 38a of the latch tongue 38 along the arrow, the protrusion 38a of the latch tongue 38 rotates while upwardly moving to the right side in the drawing.

Since the latch tongue 38 is connected with the latch bolt by the rotating pine 341, the latch bolt moves to the right side along with the latch tongue if the latch tongue moves to the right side.

The latch bolt moves until the striking plate pushes the protrusion 38a of the latch tongue 38 along the arrow to move the protrusion 38a to the right side.

The locking operation of the mortise lock 10 according to the present invention will be described with reference to FIGS. 11 to 16.

Referring to FIG. 11, the heads 34 and 36 of the latch bolt and the latch tongue 38 are extended to the outside of the case through the latch bolt outlet 26a formed in the front plate 26 of the case 22. When the door is closed, the protrusion 38a of the latch tongue 38 is higher than the planes 34a and 36a of the heads 34 and 36. Accordingly, the protrusion 38a of the latch tongue 38 is first in contact with the striking plate 100 of the door frame. The striking plate 100 of the door frame pushes the protrusion 38a of the latch tongue 38 and the latch tongue 38 tends to rotate clockwise around the rotating pin 341 using the force given to close the door. However, since a clasp hook 38c at the rear of the latch tongue 38 is hanging on the protrusion 28d of the left side 28 of the case, the latch tongue 38 rotates around a point where the clasp hook 38c adjoins the protrusion 28d not around the rotating pin 341. If the latch tongue 38 rotates clockwise around the point where the clasp hook 38c adjoins the protrusion 28d, the rotating pin 341 moves to the right side.

The left end of the heads 34 and 36 connected by the rotating pin 341 moves toward the inside of the case 22 as the rotating pin 341 is pushed to the right side. The end of the latch tongue 38 also moves to the right side as the heads 34 and 36 move to the right side. At this time, the inclined surface 38b of the latch tongue 38 tends to rotate to become identical with the inclined surfaces 34b and 36b. Referring to FIG. 9B, the rotating pin 341a little moves to the right side as the door starts to be closed in a state of FIG. 9A. Thus, the end of the heads 34 and 36 and the end of the latch tongue 38a little move to the right side, and the latch tongue 38 rotates, whereby the inclined surface 38b of the latch tongue 38 tends to rotatably move to become identical with the inclined surfaces 34b and 36b of the latch bolt.

Referring to FIG. 12, since the protrusion 38a of the latch tongue 38 is still higher than the planes 34a and 36a, it is in contact with the striking plate 100, whereby the latch tongue 38 tends to rotate clockwise. At this time, since the clasp hook 38c of the latch tongue 38 is hanging on the protrusion 28d of the left side 28, the latch tongue 38 has to rotate around the point where the clasp hook 38c adjoins the protrusion 28d not around the rotating pin 341.

The left end of the heads 34 and 36 connected by the rotating pin 341 moves toward the inside of the case 22 as the rotating pin 341 is pushed to the right side. The end of the latch tongue 38 also moves to the right side as the heads 34 and 36 move to the right side. At this time, the inclined surface 38b of the latch tongue 38 tends to rotate to become more identical with the inclined surfaces 34b and 36b of the latch bolt. Referring to FIG. 9C, the rotating pin 341a little moves to the right side as the door starts to be closed in the state of FIG. 9B. Thus, the end of the heads 34 and 36 and the end of the latch tongue 38 a little move to the right side, and the latch tongue 38 rotates, whereby the inclined surface 38b of the latch tongue 38 tends to rotatably move to become identical with the inclined surfaces 34b and 36b of the latch bolt.

As the door is further closed in the state of FIG. 13, the protrusion 38a of the latch tongue 38 is in contact with the striking plate 100, whereby the latch tongue 38 further rotates clockwise. At this time, since the clasp hook 38c of the latch tongue 38 is hanging on the protrusion 28d of the left side 28, the latch tongue 38 has to rotate around the point where the clasp hook 38c adjoins the protrusion 28d not around the rotating pin 341.

The left end of the heads 34 and 36 connected by the rotating pin 341 moves toward the inside of the case 22 as the rotating pin 341 is pushed to the right side. The end of the latch tongue 38 also moves to the right side as the heads 34 and 36 move to the right side. At this time, the inclined surface 38b of the latch tongue 38 rotates to become identical with the inclined surfaces 34b and 36b of the latch bolt.

Referring to FIG. 14, the rotating pin 341 moves to the right side as the door is further closed in the state of FIG. 13. Thus, the end of the heads 34 and 36 and the end of the latch tongue 38 move to the right side, and the latch tongue 38 rotates, whereby the inclined surface 38b of the latch tongue 38 becomes identical with the inclined surfaces 34b and 36b of the latch bolt.

In the state of FIG. 14, the striking plate 100 of the door frame is in contact with the inclined surfaces of the heads 34 and 36. In this case, the inclined surfaces 34b and 36b of the latch bolt is pushed by the striking plate 100, and the force given to allow the striking plate 100 to push the inclined surfaces of the latch bolt acts as a horizontal component force to move the rotating pin 341 to the right side. The left end of the heads 34 and 36 connected by the rotating pin 341 and the left end of the latch tongue 38 move toward the inside of the case 22 as the rotating pin 341 moves to the right side. FIG. 15 illustrates the state that the rotating pin has moved to the right side. That is, referring to FIG. 15, the striking plate 100 of the door frame is in contact with the inclined surfaces of the heads 34 and 36 in the state of FIG. 14. In this case, the inclined surfaces 34b and 36b of the latch bolt are pushed by the striking plate 100, and the force given to allow the striking plate 100 to push the inclined surfaces of the latch bolt acts as a horizontal component force to move the rotating pin 341 to the right side.

As the door is further closed in the state of FIG. 15, the striking plate 100 of the door frame further pushes the inclined surfaces of the heads 34 and 36. Thus, the latch bolt pushed by the striking plate 100 is completely inserted into the case (FIG. 15).

If the door is completely closed in a state that the latch bolt pushed by the striking plate 100 is completely inserted into the case (FIG. 15), a space 100a provided in the striking plate 100 is formed at the front of the heads 34 and 36. For this reason, the force given to allow the striking plate to push the heads 34 and 36 is removed. In this state, the latch bolt is pushed to the left side by the force of a spring 323, so that the heads 34 and 36 are taken out of the case through the latch bolt outlet 26a and inserted into the space 100a, thereby locking the door (FIG. 16).

Next, the operation of taking the heads of the latch bolt out of the space 100a formed in the striking plate 100 when the door handle is turned to open the door will be described with reference to FIGS. 17 to 19.

First, the body 32 of the latch bolt is pushed to the left side by elasticity of the spring 323 in a state that the door is closed. The heads 34 and 36 of the latch bolt connected with the body of the latch bolt are taken out of the case 22 through the latch bolt outlet 26a formed in the front plate 26 of the case 22 and then inserted into the space 100a formed in the striking plate (FIG. 17).

If the door handle is turned to open the door in the state of FIG. 17, the spindle connected with the door handle is rotated. Since the spindle is inserted into a starlike spindle through hole 42b formed in the hub 42, the hub 42 is rotated as the spindle is rotated. If the hub 42 is rotated, two petal-like cam surfaces 42c are rotated and at the same time downwardly pushes the rotating ring 54 fitted into the cam surfaces 42c. If the rotating ring 54 is pushed by the cam surfaces 42c, the push lever member 52 rotates around the first boss 281 serving as a pivot shaft and moves down toward an opposite side of the pivot shaft while downwardly pushing the rotating member 64 fitted into the lever 62. The end 62c of the lever 62 rotates clockwise around the second boss 283 serving as a pivot shaft as the rotating member 64 moves down, whereby the body of the latch bolt is inserted into the case (FIG. 18).

The spindle connected with the door handle is completely rotated to allow the petal-like cam surfaces 42c to completely move the rotating ring 54 down. Also, the end 62c of the lever 62 is completely rotated clockwise around the second boss 283 so that the heads of the latch bolt are taken out of the service hole of the door frame. In this state, if the user opens the door by pulling it (FIG. 18).

### INDUSTRIAL APPLICABILITY

The present invention can usefully be used for a mortise lock.

1. A mortise lock comprising:
a case including a front wall having an opening and a lateral wall having a latch tongue hook hole;
a latch bolt including a body and heads, the heads having a first part extended from the body and exposed to the outside of the case through the opening formed in the front wall and a second part obliquely extended from an end of the first part; and
a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion,
wherein the rotational shaft of the latch tongue is rotatably moved into the case by a force, which is given to allow the striking plate of the door frame to push the protrusion of the latch tongue, so as to insert the first part of the heads of the latch bolt into the case, and the striking plate of the door frame pushes an inclined surface of the second part of the heads of the latch bolt so as to insert the second part of the heads into the case.

2. A mortise lock comprising:
a case including a front wall having an opening and a lateral wall having a latch tongue hook hole;
a latch bolt including a body and heads, the heads having a first part extended from the body and exposed to the outside of the case through the opening formed in the front wall and a second part obliquely extended from an end of the first part to have a gradually decreased sectional area; and
a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion,
wherein the rotational shaft of the latch tongue is rotatably moved into the case by a force, which is given to allow the striking plate of the door frame to push the protrusion of the latch tongue, so as to insert the first part of the heads of the latch bolt into the case, and the striking plate of the door frame pushes an inclined surface of the second part of the heads of the latch bolt so as to insert the second part of the heads into the case.

3. A mortise lock comprising:
a case including a front wall having an opening and a lateral wall having a latch tongue hook hole;
a latch bolt including a body and heads, the heads having a first part of a constant sectional area extended from the body and exposed to the outside of the case through the opening formed in the front wall, and a second part obliquely extended from an end of the first part to have a gradually decreased sectional area; and
a latch tongue including a protrusion rotatably fixed to the body of the latch bolt and protruded to be in contact with a striking plate of a door frame prior to the heads of the latch bolt and a hook hanging on the latch tongue hook hole of the case, the latch tongue being provided with a rotational shaft nearer to the case than the protrusion,
wherein the rotational shaft of the latch tongue is rotatably moved into the case by a force, which is given to allow the striking plate of the door frame to push the protrusion of the latch tongue, in a state that the hook of the latch tongue is hanging on the latch tongue hook hole until the protrusion of the latch tongue becomes identical with a height of the first part of the latch bolt, and the striking plate of the door frame pushes the second part of the heads of the latch bolt so as to insert the second part of the heads into the case after the protrusion of the latch tongue becomes identical with the eight of the first part of the latch bolt.
